(19) United States
(12) Patent Application Publication
(10) Pub. No.: US 2002/0015020 A1
(43) Pub. Date: Feb. 7, 2002

(54) Radio-style hollow appliance for interactive use with a computer

(76) Inventor: Farzad Mobin, San Francisco, CA (US)

Correspondence Address: Robert Toczycki, 4777 Clydelle Ave., # 3, San Jose, CA, 95124, US

(21) Appl. No.: 09/917,487

(22) Filed: Jul. 27, 2001

Related U.S. Application Data
(60) Provisional application No. 60/221,876, filed on Jul. 29, 2000.

(51) Int. Cl. G09G 5/00

(52) U.S. Cl. 345/156

(57) ABSTRACT

A hollow appliance that serves to imitate existing electronic appliances by offloading their functional capability to a computer or the Internet. By providing a simple human and computer interface, human requests are conveyed to the computer via pushbutton and knob-type interactions as exercised on conventional radio-style electronic appliances and the computer fulfills the desired functions instead of the appliance itself.

### CROSS-REFERENCE TO RELATED APPLICATIONS

The present application is related to, and claims priority in, co-pending U.S. Provisional Patent Application Ser. No. 60/221,876, entitled “Computer or Internet Powered Hollow Appliances,” filed on Jul. 29, 2000.

### BACKGROUND OF THE INVENTION

1. Field of the Invention

The present invention relates generally to a hollow appliance connected to a computer, and more particularly to a user-friendly radio-style panel connected to a computer that simplifies and adds functionality to a computer.

2. Description of the Background Art

As computers continue to improve and the Internet continues to expand, computer users are given access to an unlimited amount of tools and resources. However, to utilize the various tools on the computer or on the Internet a user needs to perform several interactions utilizing the mouse and/or keyboard in combination with their computer monitor.

If a user desires to find and tune to a radio station on the Internet, he must open an application in a window on the computer monitor, find a radio station he desires to listen to, and select that particular program. This process is burdensome to most users since quite a number of mouse clicks and/or key strokes are necessary just to tune into a radio station. Such can also be the case for other types of applications including: video playback, CD playing, audio/video recording, audio/video email, and even purchasing products over the Internet.

Various features have been added to the computer over the years in order to make the computer more user-friendly, such as adding keys or buttons to keyboards or monitors to initiate functions such as playing a CD track or getting instant access to the Internet. However, these added keys do not provide a familiar look or feel to the user, and are also highly restrictive to performing single commands such as opening a web browser or to skip one CD track. These keys do not provide for a complete set of commands to perform a fully automated task such as: record in mp3 format from the microphone having an input level set to −3 db, and to save it as a particular file in a particular directory.

Therefore, there remains a need for a familiar and user-friendly appliance that can perform simple to complicated tasks in order to make the computer user's experience more powerful and enjoyable.

### SUMMARY OF THE INVENTION

This invention serves to imitate existing electronic appliances by offloading their functional capability to a computer or the Internet. In this specification the use of the word computer also implies the Internet (as a server on the Internet), if the Internet is not explicitly mentioned, it can also relate to an Internet appliance, a video game having processing power and a memory, or other computer appliance that can process and handle requests in a memory. By providing a simple human and computer interface, human requests are conveyed to the computer via pushbutton and knob-type interactions as exercised on conventional radio-style electronic appliances and the computer fulfills the desired functions instead of the appliance itself.

This invention describes the class of hollow devices that physically look and act like existing or new electronic appliances. The device will act as a hardware client while it employs a minimal set of input and output components that convey human interactions with the computer. The computer in turn provides the behavior previously associated with the conventional appliance. The behavior includes audio, video, other sensory feedbacks, or in the form of performing an automated task. The intelligent behavior of the hollow device will take place on the computer or over the Internet. This leaves the hollow appliance with mostly on/off switches, relays, sensors, transducers, and interfaces. It is devoid of mass storage, computer-type CPU power, and other digital or analog appliance type circuitry. In this sense it is a hollow appliance and acts as a generic or specialized control fixture to cause the computer to perform useful tasks.

The advantages of a hollow appliance or hollow/conventional combinations are lower manufacturing costs, less electronic circuitry and the sharing of many common resources on the attached computer. Every hollow device connected to a computer can utilize the computer's CPU, mass storage, multimedia capability, CD Rom, DVD Rom access, and Internet capability, given that the attached computer provides these resources. Additionally, it can provide new capabilities not available on the conventional non-hollow equivalent as it has access to various rich resources of the attached computer. A computer user armed with a hollow appliance having a familiar style can make the computer user's experience much more productive, enjoyable and therefore make the computer easier to use.

For a person not familiar with computers, the hollow appliance provides an easy method of interacting with a computer through familiar conventional physical appliance forms. The user can immediately make phone calls, listen to the radio, listen to the CD player, and record from any source, etc. In many cases the user will not need to use the computer's monitor, keyboard, or the mouse. This allows a stepping-stone for the novice to enter the world of computers and can facilitate the purchase decision of a computer for such novices.

Other advantages and features of the present invention will be apparent from the drawings and detailed description as set forth below.

### BRIEF DESCRIPTION OF THE DRAWINGS

FIG. 1 is a schematic diagram of a computer system incorporating the present invention showing how it can be mounted on a computer monitor;

FIG. 2 is a front view of one embodiment of the radio-style hollow appliance in accordance with the present invention;

FIG. 3 is a block diagram illustrating various features of the radio-style hollow appliance, according to the present invention; and

FIG. 4 is a diagram of another type of embodiment of the radiostyle hollow appliance in combination with a computer monitor in accordance with the present invention.

### DETAILED DESCRIPTION OF THE PREFERRED EMBODIMENT

The present invention provide a radio-style hollow appliance that allows a user to interactively use the appliance in conjunction with the attached computer in order to increase the functionality of the computer for the user. A simple computer interface is provided wherein human requests are conveyed to the computer via pushbutton and knob-type interactions, and the computer fulfills the desired functions instead of the appliance itself.

The hollow appliance of the present invention delegates all of its core functionality to an attached computer or to a computer over the Internet. By commanding the attached resources, the hollow appliance performs the task that the consumer expects. Because the appliance is virtually “hollow,” the cost associated in manufacturing this appliance is much less than a non-hollow equivalent, since the hollow appliance contains significantly less electronic components while providing the same or more functionality. This is achieved by employing preprogrammed software on the attached computer or over the Internet.

For the traditional computer user, accessing many of the entertainment and communications functions now require several interactions with the mouse and the keyboard. Through the use of the radio-style hollow appliance of the present invention, these operations now become simple and familiar push button operations.

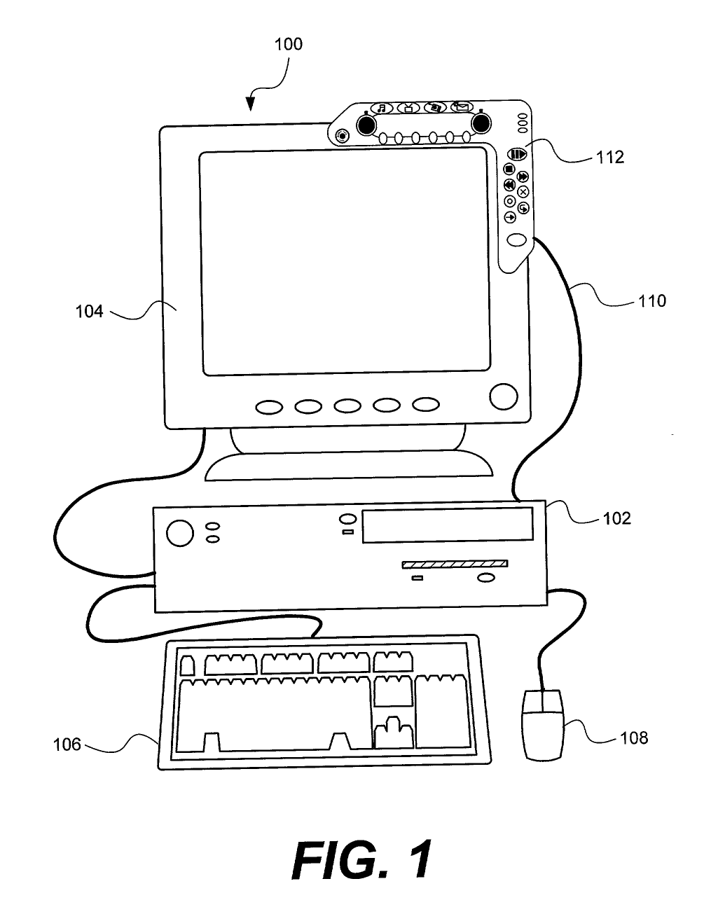

Referring now to the drawings, FIG. 1 is a schematic diagram of a computer system 100 having a computer 102 connected with a monitor 104, a keyboard 106, and a mouse 108. Cable 110 attaches the radio-style hollow device 112 to the computer via one of the computer input ports. The type of input used to attach the hollow device 112 can vary; excellent results can be obtained by attaching the hollow device to a USB port. Other type of input ports, such as parallel ports, serial ports, firewire ports, and PCI ports can also be used. The hollow appliance can also be wireless and act as a remote control to initiate the user-desired services. The hollow device 112 is preferably mounted and positioned in such a location so as to make it easy for a user to access, such as an upper corner of the computer monitor 104.

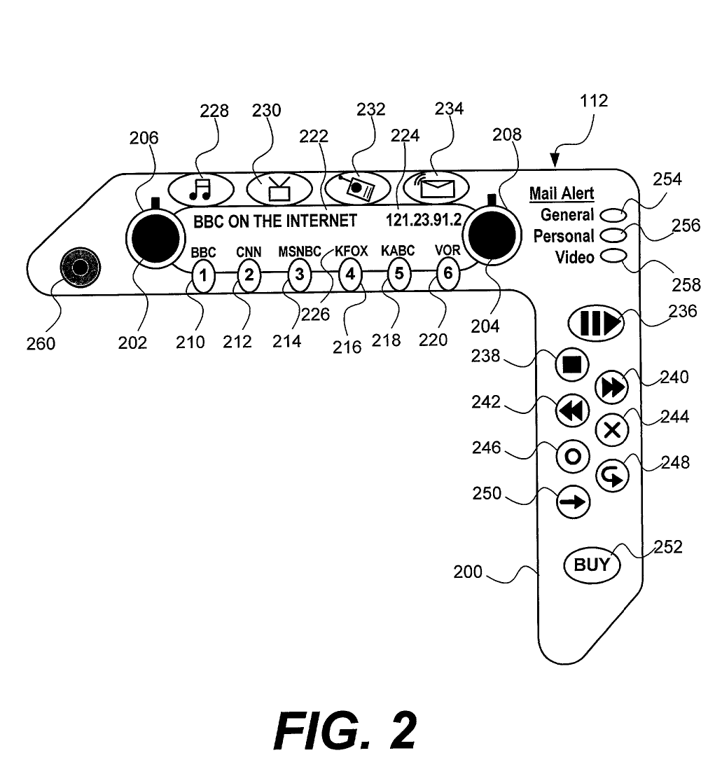

FIG. 2 is a front view of one embodiment of the radio-style hollow appliance 112. The hollow appliance 112 is built on a panel 200, preferably made of plastic, however, other materials can also be used. The hollow device 112 includes various types of buttons, knobs and displays designed in a familiar radio-style (such as a car radio), thereby making it easy for a user to quickly acquaint themselves with the hollow device 112. The knobs and buttons on the hollow device 112 basically transmit to the connected computer which buttons or knobs were pressed or turned. Associated software on the computer is programmed to perform the tasks selected on the hollow device.

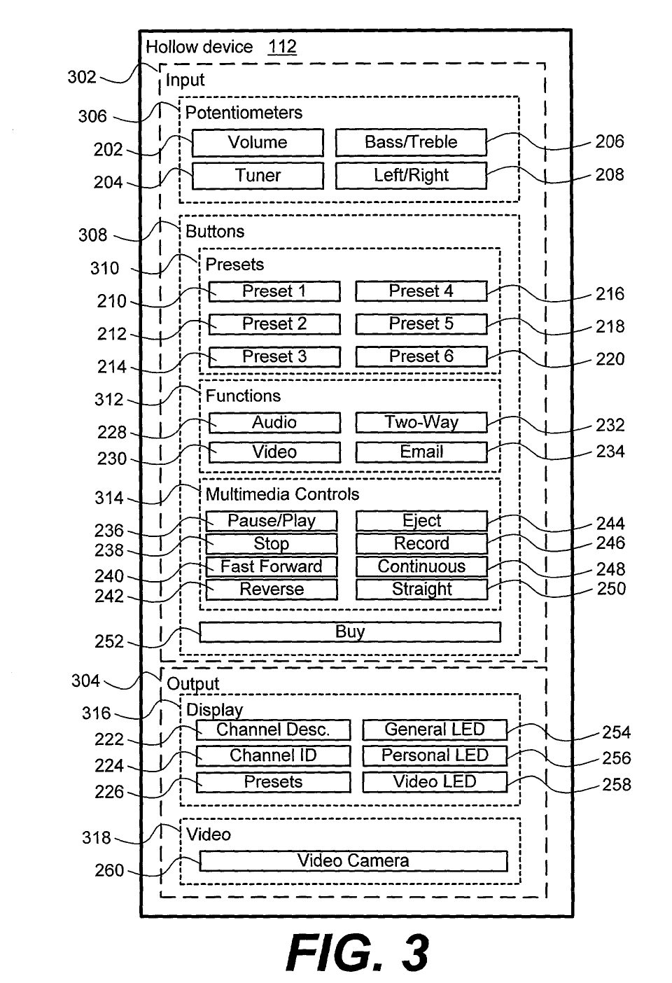

The hollow device 112 has a number of input devices 302 and output devices 304 (FIGS. 2, 3). The input devices include a set of potentiometers 306 including a volume knob 202 (FIGS. 2, 3), a tuner knob 204, a bass/treble knob 206, and a left/right speaker knob 208. The hollow device also includes a number of buttons 308. One group of buttons includes six preset station buttons 210, 212, 214, 216, 218, 220, along with a descriptive display section 222, a channel ID display section 224, and a display section 226 for each of the six preset station buttons.

A set of function buttons 312 are also provided for the user. They include an audio button 228, a video button 230, a two-way button 232, and an email button 234.

A set of multimedia buttons 314 are also placed on the hollow-device 112. The buttons include a pause/play button 236, a stop button 238, a fast-forward button 240, a reverse button 242, an eject button 244, a record button 246, a continuous or repeat button 248, and a straight or no-repeat button 250. These multimedia buttons can control CD Rom drive operations, DVD Rom drive operations, record audio and/or video being received over the computer or over a microphone, control email, control voice mail, and work with any other desired functions.

The multimedia control buttons 314 can also manage a hollow-type answering machine. The answering machine can manage web-based voice mail or voice mail over ordinary telephone lines. The user can interact with his or her voice mail service via a push button input, so the “play” button 236 will play all the new messages, the “rewind” button 242 will go back a message, the “fast-forward” button 240 will go forward one, and the “delete” key will delete the message. In a web-based voice mail or voice email environment, a user will no longer need to use a browser or navigation to get to voice mail.

For voice mail managed by a telephone company, the software managing the hollow appliance handshakes in dtmf with the voice mail service. When the user pushes the “play” button 236, the software will command the computer to dial the access number, authorization code, and the key sequence to start playing messages. All other voice mail keys are mapped to the appropriate tones. Therefore, there is no longer a need to memorize any numbers, codes, or commands.

Other buttons and/or knobs can also be incorporated to make a user's computer experience easier to use. For example, a “buy” button 252 is also included on the hollow device, wherein the button is programmed to automatically purchase a selected item on the computer. The “buy” button would authorize a user's credit card to be automatically billed and to complete a transaction over the Internet.

LED alerts are also provided for on the hollow device. A general alert LED 254 is programmed to light up when any email and/or voice mail is received. A personal alert LED 256 is programmed to light up when an email from someone on a designated personal list is received. A video alert LED 258 is programmed to light up when a video email is received. As a user receives an email, computers can be programmed to flash an alert on the computer monitor, however, these alerts are often annoying since they can pop-up in the middle of active session. These LED alerts provide passive notification to the computer user without flashing the alert on the computer monitor in an active session.

Video 318 can also be used in conjunction with the hollow device 112. A small video camera 260 can be mounted into the panel 200 for additional features, such as video conferencing and video email. Also video can be recorded through the connected computer on some non-volatile memory.

To listen to a radio station in a car requires pushing one button. To listen to Internet radio on a computer is considerably more complicated. Currently, to listen to the Internet radio, one maneuvers the mouse, navigates through menus, clicks on choices and finally hears the radio play. This process is time consuming and will deter the user's attention from whatever he or she may be doing with the computer at the time as the screen content changes in the process. The radio-style hollow device 112 makes the computer radio navigation experience equivalent to the car radio experience. After selecting audio function 228, the user can tune into an Internet radio program or to an audio file (such as an mp3 song) with the tuner 204, or just push one of the six presets 210, 212, 214, 216, 218, 220, and the radio station or audio file plays. The descriptive display 222 describes the selected channel and the channel ID 224 displays an associated address. The computer monitor is unaffected by the selection and the user does not need to open and close windows just to play the radio, nor does the user need to use the mouse or the keyboard.

In a similar fashion, video files located on the computer or on the Internet can also be accessed by pressing the video function button 230, and then tuning to the desired video program via the presets or the tuning knob. The video program would then be displayed on the computer monitor for the user to watch.

Pushing the two-way button 232 can also deploy a two-way radio or a hollow intercom. The tuning knob and/or the presets allow the user to select individuals with which to instantly communicate with. The software programmed with this feature will automatically connect with the selected party. This can be accomplished over the Internet or even over an ordinary telephone network. The display shows the status of the potential connectable parties as present or absent, so that only the present people will be attempted for a connection. The twoway button 232 can also transmit video via the video camera 260 in addition to audio.

Existing or potential computer users can employ existing experiences to use hollow appliances or derive useful functions from a computer, as they already know how to work with conventional appliances such as radios, camcorders, answering machines, cassette recorders, VCR's, cordless phones, etc. and the users are comfortable with push button operations to complete a full automated task.

Push the radio button 228, push the red-dotted recording button 246, turn the ring-knob 208 for balance, turn the tuning knob 204 to seek the next station. Press play 236 to get the new messages out of a computer-based answering machine. Previous to this invention, a complex set of user interactions would be required to perform a service instead of pushing one or two buttons.

Embodiments of this invention allow the computer novice to immediately have access to many computer services while it acts as a time saver for the experienced user. Hollow appliances can be built as add-on devices for existing computers or can be built-in as part of the monitor, keyboard, mouse, or the CPU box on new computers.

Some additional features that can be programmed with the hollow device include a hollow cassette player/recorder with no physical cassette media. Instead it uses the hard drive to record audio. It can employ all the familiar knobs of rewind, fast-forward, stop, play and record to make recordings of either the computer microphone, Internet radio, or any other audio source. It can provide for multiple formats including wave, conventional audio, mp3, liquid audio, etc. It can incorporate the mechanism to record on pre-determined schedules from any audio or video content in the user's absence. This feature can also be programmed one step further into a hollow VCR, incorporating the same functionality as the hollow cassette with video capability.

The same invention can be employed to build hollow radios, accessing Internet radio from a computer or directly from the Internet; hollow cassette player/recorders; hollow VCRs; hollow video telephones; hollow CD/ DVD players; or hollow generic panels to implement a battery of such functions. The invention can also automate multi-step functions such as one button to copy paper from scanner to printer, one button data backup, or one button CD duplication.

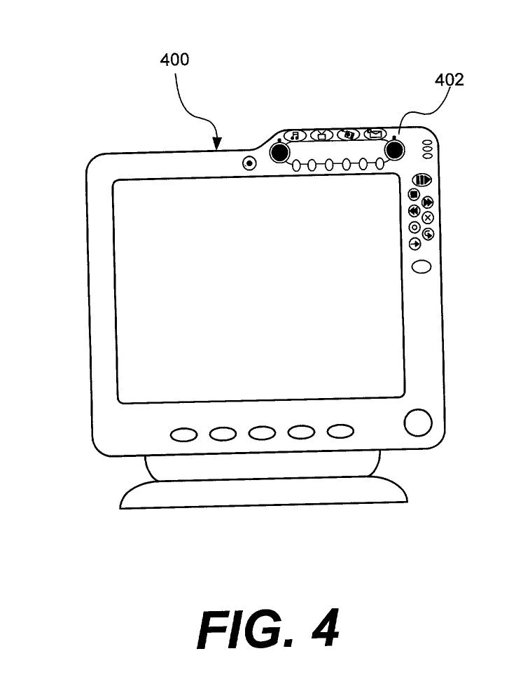

FIG. 4 illustrates another type of embodiment of the radio-style hollow appliance, wherein the hollow appliance 402 is already incorporated into a computer monitor 400. The hollow appliance can also be integrated in other various computer components, such as a computer keyboard, a computer mouse, or even a mouse pad.

The invention has been explained above with reference to a preferred embodiment. Other embodiments will be apparent to those skilled in the art in light of this disclosure. For example, the invention may be implemented in other configurations and/or used with other systems. Therefore, these and other variations upon the preferred embodiments are intended to be covered by the appended claims.

What is claimed is:

1. A radio-style hollow appliance connected to a computer, said hollow appliance comprising:
input means and display means arranged in such a manner so as to resemble input and display features on a radio, and
software means running on said computer, said software means providing a response to commands received from said input means and displaying information related to said input means on said display means.

2. The radio-style hollow appliance of claim 1, wherein said input means includes a volume knob and a tuning knob.

3. The radio-style hollow appliance of claim 2, wherein said input means further includes a set of preset station buttons.

4. The radio-style hollow appliance of claim 1, wherein said response includes co nnecting to an audio source through the computer.

5. The radio-style hollow appliance of claim 1, wherein said response includes connecting to a video source through the computer.

6. The radio-style hollow appliance of claim 1, wherein said hollow appliance is integrated into a computer component.

7. The radio-style hollow appliance of claim 6, wherein said computer component is selected from the group consisting of: a computer monitor, a computer keyboard, a computer mouse, and a mousepad.

8. An answering machine-style hollow appliance connected to a computer, said hollow appliance comprising:
input means arranged in such a manner so as to resemble input features on an answering machine, and
software means running on said computer, said software means providing a response to commands received from said input means so as to emulate an answering machine.

9. The answer machine-style hollow appliance of claim 8, wherein said input means includes a play button, a stop button, a rewind button, a fast-forward button, a record button, and a delete button.

10. The answering machine-style hollow appliance of claim 8, wherein said response includes connecting to a voice mail source through the computer.

11. The answering machine-style hollow appliance of claim 8, wherein said response includes connecting to a video mail source through the computer.

12. The answering machine-style hollow appliance of claim 8, wherein said hollow appliance is integrated into a computer component.

13. The answering machine-style hollow appliance of claim 12, wherein said computer component is selected from the group consisting of: a computer monitor, a computer keyboard, a computer mouse, and a mousepad.

14. A video-style hollow appliance connected to a computer, said hollow appliance comprising:
input means and display means arranged in such a manner so as to resemble input and display features on a video camera, and
software means running on said computer, said software means providing a response to commands received from said input means and displaying information related to said input means on said display means.

15. The video-style hollow appliance of claim 14, wherein said input means includes a video camera, a play button, a stop button, a rewind button, a fast-forward button, and a record button.

16. The video-style hollow appliance of claim 14, wherein said response includes connecting to a non-volatile memory source through the computer.

17. The video-style hollow appliance of claim 14, wherein said hollow appliance is integrated into a computer component.

18. The video-style hollow appliance of claim 13, wherein said computer component is selected from the group consisting of: a computer monitor, a computer keyboard, a computer mouse, and a mousepad.
